(19) United States
(12) Patent Application Publication
(10) Pub. No.: US 2012/0103526 A1
(43) Pub. Date: May 3, 2012

(54) HIGH PURITY ALUMINUM COATING HARD ANODIZATION

(75) Inventors: Alan Ouye, San Mateo, CA (US); Renee Marguerite Koch, Brentwood, CA (US)

(73) Assignee: APPLIED MATERIALS, INC., Santa Clara, CA (US)

(21) Appl. No.: 13/276,493

(22) Filed: Oct. 19, 2011

Related U.S. Application Data
(60) Provisional application No. 61/407,901, filed on Oct. 28, 2010.

(51) Int. Cl. B32B 15/04; C23C 28/00; C25D 11/16; B44C 1/22

(52) U.S. Cl. 156/345.51; 428/632; 205/190; 205/172

(57) ABSTRACT

The disclosure relates to a chamber component or a method for fabricating a chamber component for use in a plasma processing chamber apparatus. The chamber component includes a polished high purity aluminum coating and a hard anodized coating that is resistive to the plasma processing environment.

### CROSS-REFERENCE TO RELATED APPLICATIONS

This application claims benefit of U.S. Provisional Application Ser. No. 61/407,901 filed Oct. 28, 2010, (Attorney Docket No. APPM/13911L), which is incorporated by reference in their entirety.

### BACKGROUND

1. Field

The present disclosure relates generally to tools and components for use in a plasma processing chamber apparatus. More specifically, the present disclosure relates to a method for producing a plasma processing chamber component that is resistive to the corrosive plasma environment.

2. Description of the Prior Art

Semiconductor processing involves a number of different chemical and physical processes whereby minute integrated circuits are created on a substrate. Layers of materials which make up the integrated circuit are created by chemical vapor deposition, physical vapor deposition, epitaxial growth, and the like. Some of the layers of material are patterned using photoresist masks and wet or dry etching techniques. The substrate utilized to form integrated circuits may be silicon, gallium arsenide, indium phosphide, glass, or other appropriate material.

A typical semiconductor processing chamber includes a chamber body defining a process zone, a gas distribution assembly adapted to supply a gas from a gas supply into the process zone, a gas energizer, e.g., a plasma generator, utilized to energize the process gas to process a substrate positioned on a substrate support assembly, and a gas exhaust. During plasma processing, the energized gas is often comprised of ions and highly reactive species which etches and erodes exposed portions of the processing chamber components, for example, an electrostatic chuck that holds the substrate during processing. Additionally, processing by-products are often deposited on chamber components which must be periodically cleaned typically with highly reactive fluorine. In-situ cleaning procedures used to remove the processing byproducts from within the chamber body may further erode the integrity of the processing chamber components. Attack from the reactive species during processing and cleaning reduces the lifespan of the chamber components and increase service frequency. Additionally, flakes from the eroded parts of the chamber component may become a source of particulate contamination during substrate processing. As such, the chamber components must be replaced after a number of process cycles and before they provide inconsistent or undesirable properties during substrate processing. Therefore, promoting plasma resistance of chamber components is desirable to increase service life of the processing chamber, reduce chamber downtime, reduce maintenance frequency, and improve substrate yields.

Conventionally, the processing chamber surface may be anodized to provide a degree of protection from the corrosive processing environment. Alternatively, dielectric and/or ceramic layers, such as aluminum nitride (AlN), aluminum oxide (Al2O3), silicon oxide (SiO2), or silicon carbide (SiC), may be coated and/or formed on the component surface to promote the surface protection of the chamber components. Several conventional methods utilized to coat the protective layer include physical vapor deposition (PVD), chemical vapor deposition (CVD), sputtering, plasma spraying coating, aerosol deposition (AD) and the like. The conventional coating techniques typically employ a substantially high temperature to provide sufficient thermal energy to sputter, deposit or eject a desired amount of materials on a component surface. However, high temperature processing may deteriorate surface properties or adversely modify the microstructure of the coated surface, resulting in a coated layer having poor uniformity and/or surface cracks due to temperature elevation. Furthermore, if the coated layer or the underlying surface has microcracks or the coatings are not applied uniformly, the component surface may deteriorate over time and eventually expose the underlying component surface to corrosive plasma attack.

Therefore, there is a need for an improved method for forming chamber components that are more resistive to a processing chamber environment.

### SUMMARY

Embodiments of the disclosure provide a chamber component for use in a plasma processing chamber apparatus. According to one embodiment of the disclosure, a chamber component is provided that includes an aluminum body having a polished aluminum coating disposed on an outer surface of the body and a hard anodized coating disposed on the aluminum coating, wherein the polished aluminum coating is polished to a finish of 8 Ra or smoother.

In another embodiment of the disclosure, an apparatus is provided for use in a plasma processing chamber having a substrate pedestal adapted to support a substrate. The apparatus generally includes a plate having a plurality of apertures formed therethrough and configured to control the spatial distribution of charged and neutral species of the plasma, the plate having a polished layer of aluminum disposed on an outer surface of the plate and a hard anodized coating disposed on the aluminum layer, wherein the layer of aluminum is polished to a finish of 8 Ra or smoother.

In one embodiment of the disclosure, a method for fabricating a plasma processing chamber component includes forming a body of the chamber component from aluminum, polishing the surface of body, depositing a layer of aluminum on the body, polishing the surface of the aluminum layer, and hard anodizing the aluminum layer.

The additional embodiments of the present disclosure will no doubt become understood to those of ordinary skill in the art after reading the following detailed description, which is illustrated in following figures and drawings.

### BRIEF DESCRIPTION OF THE APPENDED DRAWINGS

The teachings of the present disclosure can be readily understood by considering the following detailed description in conjunction with the accompanying drawings, in which:

FIG. 1 illustrates a sectional view of a chamber component having a coating according to one embodiment of the disclosure.

FIG. 2 depicts a flow diagram of one embodiment of a method for fabricating the chamber component of FIG. 1.

FIG. 3 illustrates a perspective view of an alternative embodiment of the chamber component of FIG. 1, specifically, a plasma screen.

FIG. 3A illustrates a sectional view of the plasma screen of FIG. 3.

FIG. 4 illustrates a processing chamber which uses the chamber component of FIG. 1.

To facilitate understanding, identical reference numerals have been used, where possible, to designate identical elements that are common to the figures. It is contemplated that elements disclosed in one embodiment may be beneficially utilized on other embodiments without specific recitation.

### DETAILED DESCRIPTION

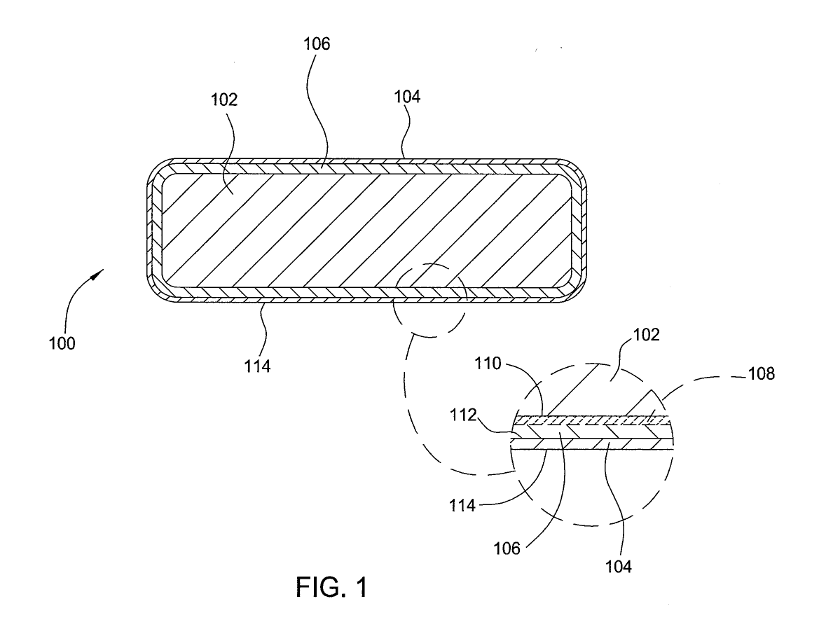

FIG. 1 illustrates a sectional view of one embodiment of a plasma processing chamber component 100 that may be used within a processing chamber. Although the chamber component 100 is shown in FIG. 1 as having a rectangular cross-section, for the purposes of discussion it is understood that the chamber component 100 may take the form of any chamber part, including, but not limited to, a chamber body, a chamber body upper liner, a chamber body lower liner, chamber body plasma door, a cathode liner, a chamber lid gas ring, a throttling gate valve spool, a plasma screen, a pedestal, a substrate support assembly, a showerhead, a gas nozzle, and the like. The chamber component 100 has at least one exposed surface 114 that is exposed to the plasma environment within the processing chamber when in use. The chamber component 100 includes a body 102 having a conformal aluminum coating 106 of high purity aluminum and a hard anodized coating 104 disposed on an outer surface 112 of the aluminum coating 106. The body 102 may optionally include an adhesion layer (shown in phantom as reference numeral 108) disposed on an outer surface 110 of the body 102 that improves the adhesion of the aluminum coating 106 to the body 102.

The aluminum coating 106 fills and bridges imperfections along the outer surface 110 of the aluminum body 102 while producing a smooth and crack-free outer surface 112. Since the outer surface 112 on which the hard anodized coating 104 is formed is substantially defect free, there are no initiation sites for cracks to form and propagate through the hard anodized coating 104, resulting in a relatively smooth and defect-free outer surface 114. The aluminum coating 106 is generally soft and ductile and is made of a high purity aluminum material. The aluminum coating 106 is generally free of intermetallics, free of surface defects from machining (i.e. it is not machined), and has no residual stress. The aluminum coating 106 is polished using a non-mechanical polish, such as a chemical polish, to improve the surface purity of the outer surface 112 of the aluminum coating 106 for anodization. In one embodiment, the outer surface 112 is polished to 16 RMS or smoother, such as 8 RMS or smaller. Polishing to remove surface impurities and establish a uniform surface enhances the crack-resistance of the overlying hard anodized coating 104. Generally, the aluminum coating 106 has a thickness such that the underlying body 102 is not affected by the hard anodization process. In one embodiment, the aluminum coating 106 may have a thickness of at least 0.002 inches, such as 0.003 inches.

Optionally, an adhesion layer 108 disposed on the outer surface 110 may improve adhesion of the aluminum coating 106 to the chamber component 100. The adhesion layer 108 may additionally act as a barrier layer between the body 102 and the aluminum coating 106 against the migration of impurities from the body 102 into the subsequently deposited aluminum coating 106. In one embodiment, the adhesion layer 108 is a thin nickel flash layer.

The anodized coating 104 covers and encapsulates the aluminum coating 106 and the body 102 and forms the surface 114 that is exposed to the plasma environment of a processing chamber. The anodized coating 104 generally resists the corrosive elements found within the process volume and protects the chamber component from decay and wear. In one specific embodiment, the anodized coating 104 has a thickness of 0.002 inches±0.0005 inches. In another example, the anodized coating 104 has a thickness of approximately 0.0015 inches±0.0002 inches.

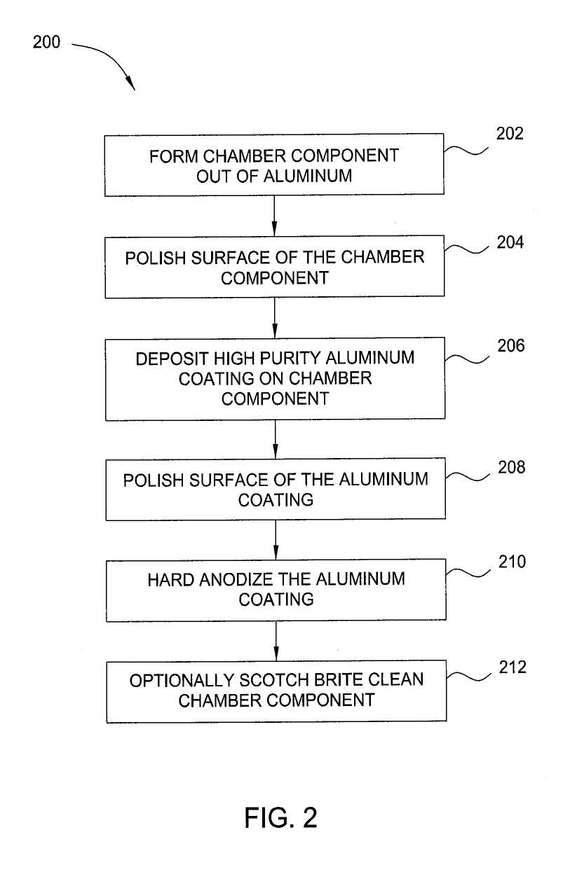

FIG. 2 depicts a flow diagram of one embodiment of a method 200 that may be used to fabricate the chamber component shown in FIG. 1. As mentioned above, the method 200 may readily be adapted for any suitable chamber component, including a substrate support assembly, a showerhead, a nozzle, and a plasma screen, among others.

The method 200 begins at block 202 by forming a body 102 out of aluminum. In one embodiment, the body 102 is made of a base aluminum, such as 6061-T6 aluminum. Conventional aluminum components not fabricated using the method 200 described herein have unreliable quality and inconsistent surface features that may lead to the formation of cracks and crazes on the surface of the chamber component 100 after the component has been exposed to a plasma environment. As such, further processing, as described in detail below, is desirable to create a robust, plasma resistant component.

At block 204, the outer surface 110 of the body 102 is polished to reduce surface imperfections which conventionally would lead to cracking at the anodized coating. It is noted that one skilled in the art would regard having less surface cracking and crazing on the body 102 as more important than the thickness of a hard anodized coating for the purposes of particle reduction and film life. The outer surface 110 may be polished using any suitable electropolishing or mechanical polishing method or process, for example such as described by ANSI/ASME B46.1. In one embodiment, the outer surface 110 may be polished to a finish of 8 μin Ra or smoother.

At block 206, an aluminum coating 106 is deposited on the outer surface 110 of the body 102. The aluminum coating 106 may be produced by a variety of methods. In one embodiment, a layer of high purity aluminum metal may be electrodeposited on the outer surface 110 of the body 102. In another embodiment, an ion vapor deposition (IVD) process may be used to deposit the aluminum coating 106 on the outer surface 110 of the body 102.

At block 208, the outer surface 112 of the aluminum coating 106 is polished to remove surface impurities from the outer surface 112. In one embodiment, the outer surface 112 may be polished using a non-mechanical polish, such as a chemical polish or electropolish, to remove impurities found on the surface. For example, the outer surface 112 may be polished to a finish of 8 μin Ra or smoother. This finishing step advantageously reduces the likelihood of cracks or crazes being formed after chamber component 100 is hard anodized.

At block 210, the outer surface 112 of the aluminum coating 106 is hard anodized to form an anodized coating 104 that protects the underlying metal of the chamber component from the corrosive process environment within a plasma processing chamber. The aluminum coating 106 may be anodized to form an anodized coating 104 having a thickness sufficient to adequate protection from the process environment, yet is not so thick as to aggravate surface cracks and crazes. In one specific example, the anodized coating has a thickness of 0.002 inches±0.0005 inches. In another example, the anodized coating 104 has a thickness of approximately 0.0015 inches.

Optionally, at block 212, the chamber component 100 may be cleaned to remove any high spots or loose particles on the exposed surface 114 of the anodized coating 104. In one embodiment, the chamber component 100 may be mechanically cleaned with a non-depositing material such as Scotch Brite to remove large particles or loosely attached material which may become released during operation of the processing chamber but not by a normal post-clean process. In another embodiment, the chamber component 100 may be cleaned using a 24-hour cleaning treatment sufficient to remove small residual material on the surface of the chamber component 100.

The method 200 for a high purity aluminum coating hard anodization significantly improves the integrity of the hard anodize, preventing cracks and crazes from forming in the exposed surface of a chamber component. A hydrochloric acid test for hard anodize is considered good at 8 hours of exposure without penetration into the base aluminum. A chamber component produced by the method 200 having a hard anodization as described above can advantageously maintain a significantly longer exposure before penetration into the base aluminum and produces little to no physical particles. Moreover, with the high purity aluminum coating 106, the characteristics of the base aluminum material with respect to intermetallics, surface defects, and internal structure become a less significant concern. As such, the aluminum coating 106 under the hard anodized coating 104 allows for the use of porous materials for the body 102, such as cast aluminum, when fabricating chamber components for use in vacuum environments, thereby allowing an increase in manufacturing yield as these factors become less significant in meeting specifications.

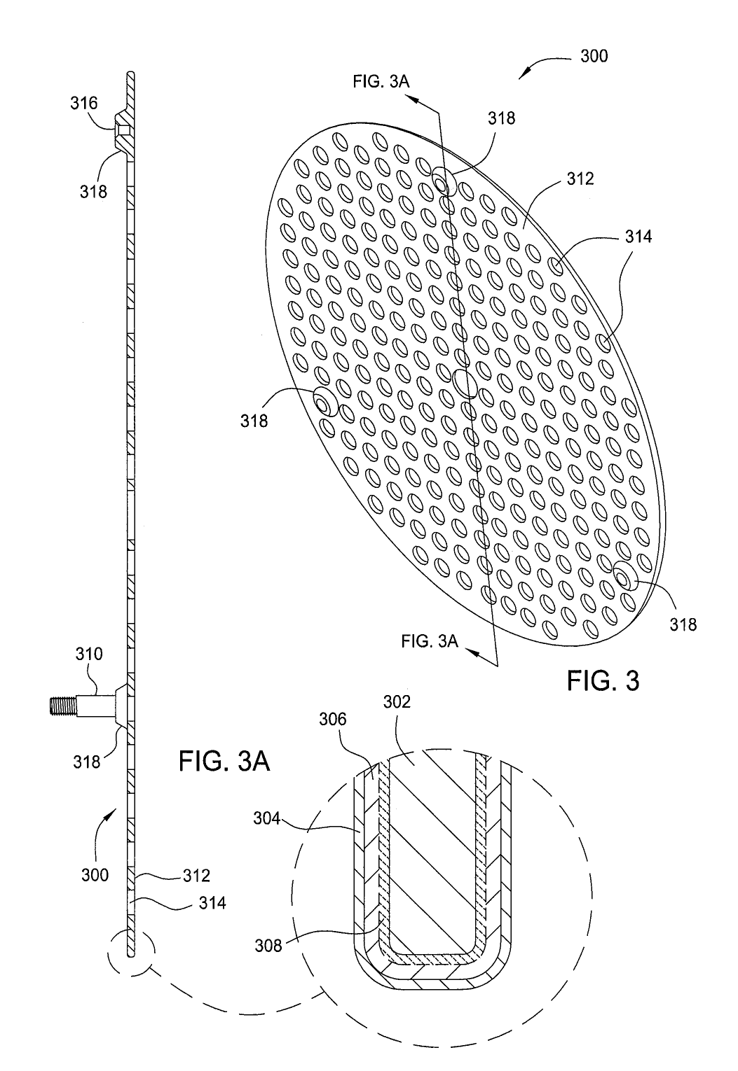

FIG. 3 illustrates one embodiment an exemplary chamber component, shown as a plasma screen 300, that may be produced using method 200. The plasma screen 300 is used in a processing chamber to distribute ions and radicals across the surface of a substrate placed within the processing chamber. As shown in FIG. 3, the plasma screen 300 generally includes a plate 312 having a plurality of apertures 314 formed therethrough. In another embodiment, the plate 312 may be a screen or a mesh wherein the open area of the screen or mesh corresponds to the desired open area provided by the apertures 314. Alternatively, a combination of a plate and screen or mesh may also be utilized.

FIG. 3A depicts a sectional view of the plasma screen 300. In the embodiment shown, the plate 312 is made of a body 302 having an aluminum coating 306 and an anodized coating 304 disposed on the surface of the body 302, as described above with reference to the chamber component 100. In one embodiment, the body 302 may be made of aluminum, for example, 6061-T6 aluminum, or any other suitable material. As discussed above, the aluminum coating 306 may be a layer of high purity aluminum deposited on the outer surface of the body 302 using a variety of methods including electrodepositing and IVD. In one embodiment, the anodized coating 304 may include a hard anodized layer that protects the body 302 from the ions encountered by the plasma screen 300 during plasma processing. It is noted that during fabrication of the plasma screen 300, the apertures 314 and holes 316 (described below) may be masked prior to the anodization process to preserve the integrity of the openings.

Returning to FIG. 3, the plurality of apertures 314 may vary in size, spacing and geometric arrangement across the surface of the plate 312. The size of the apertures 314 generally range from 0.03 inches (0.07 cm) to about 3 inches (7.62 cm). The apertures 314 may be arranged in a square grid pattern. The apertures 314 may be arranged to define an open area in the surface of the plate 312 of from about 2 percent to about 90 percent. In one embodiment, the one or more apertures 314 includes a plurality of approximately half-inch (1.25 cm) diameter holes arranged in a square grid pattern defining an open area of about 30 percent. It is contemplated that the holes may be arranged in other geometric or random patterns utilizing other size holes or holes of various sizes. The size, shape and patterning of the holes may vary depending upon the desired ion density in a process volume within a processing chamber. For example, more holes of small diameter may be used to increase the radical to ion density ratio in the volume. In other situations, a number of larger holes may be interspersed with small holes to increase the ion to radical density ratio in the volume. Alternatively, the larger holes may be positioned in specific areas of the plate 312 to contour the ion distribution in the volume.

To maintain the plate 312 in a spaced-apart relationship with respect to a substrate supported in a plasma processing chamber, the plate 312 is supported by a plurality of legs 310 extending from the plate 312. One leg 310 is illustrated in FIG. 3A for the sake of brevity. The legs 310 are generally located around an outer perimeter of the plate 312 and may be fabricated using the same materials and processes as the plate 312 as described above. In one embodiment, three legs 310 may be utilized to provide a stable support for the plasma screen 300. The legs 310 generally maintain the plate in a substantially parallel orientation with respect to a substrate or a substrate support pedestal. However, it is contemplated that an angled orientation may be used by having legs of varied lengths.

An upper end of a leg 310 may be press fit or thread into a corresponding blind hole 316 formed in a boss 318 extending in three places from an underside side of the plate 312. Alternatively, the upper end of the legs 310 may be threaded into the plate 312 or into a bracket secured to the underside of the plate 312. Other conventional fastening methods not inconsistent with processing conditions may also be used to secure the legs 310 to the plate 312. It is contemplated that the legs 310 may rest on a pedestal, adapter, or an edge ring circumscribing the substrate support. Alternatively, the legs 310 may extend into a receiving hole formed in the pedestal, adapter, or edge ring. Other fastening methods are also contemplated for securing the plasma screen 300 to the pedestal, adapter, or edge ring, such as by screwing, bolting, bonding, and the like. When secured to an edge ring, the plasma screen 300 may be part of an easily-replaceable process kit for ease of use, maintenance, replacement, and the like.

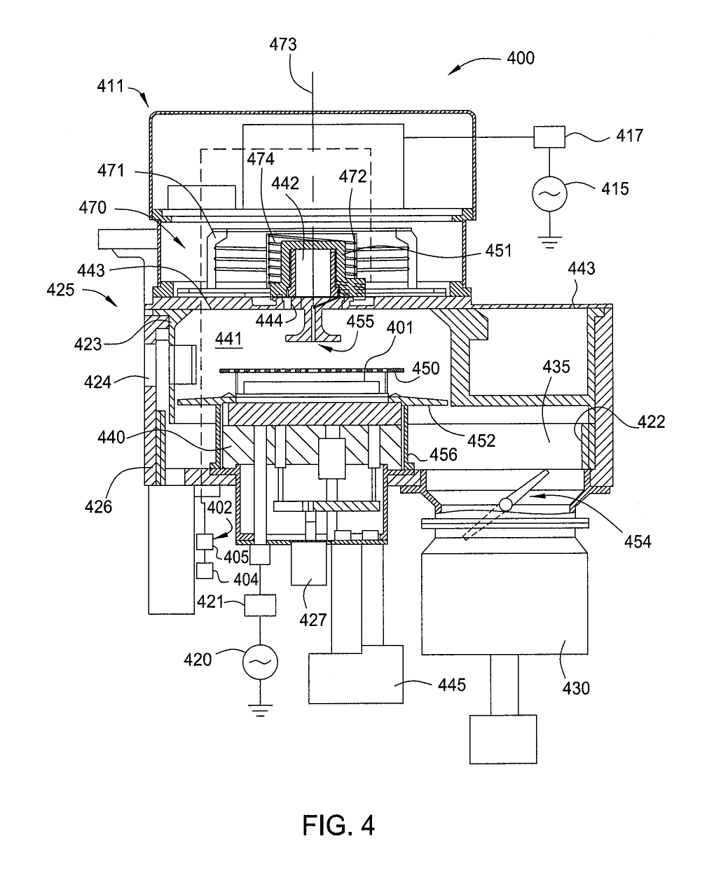

FIG. 4 schematically illustrates a plasma processing system 400. In one embodiment, the plasma processing system 400 comprises a chamber body 425 defining a processing volume 441. The chamber body 425 includes a sealable slit valve tunnel 424 to allow entry and egress of a substrate 401 from the processing volume 441. The chamber body 425 includes sidewalls 426 and a lid 443. The sidewalls 426 and lid 443 may be fabricated from aluminum, including porous aluminum, using the method 200 described above. The plasma processing system 400 further comprises an antenna assembly 470 disposed over the lid 443 of the chamber body 425. A power source 415 and a matching network 417 are coupled to the antenna assembly 470 to provide energy for plasma generation. In one embodiment, the antenna assembly 470 may comprise one or more solenoidal interleaved coil antennas disposed coaxial with an axis of symmetry 473 of the plasma processing system 400. As shown in FIG. 4, the plasma processing system 400 includes an outer coil antenna 471 and an inner coil antenna 472 disposed over the lid 443. In one embodiment, the coil antennas 471, 472 may be independently controlled. It should be noted, even though two coaxial antennas are described in the plasma processing system 400, other configurations, such as one coil antenna, three or more coil antenna configurations may be contemplated.

In one embodiment, the inner coil antenna 472 includes one or more electrical conductors wound as a spiral with small pitch and forming an inner antenna volume 474. A magnetic field establishes in the inner antenna volume 474 of the inner coil antenna 472 when an electrical current goes through the one or more electrical conductors. As discussed below, embodiments of the present disclosure provide a chamber extension volume within the inner antenna volume 474 of the inner coil antenna 472 to generate plasma using the magnetic field in the inner antenna volume 474.

It should be noted, that the inner coil antenna 472 and the outer coil antenna 471 may have other shapes according to application, for example to match a certain shape of a chamber wall, or to achieve symmetry or asymmetry within a processing chamber. In one embodiment, the inner coil antenna 472 and the outer coil antenna 471 may form inner antenna volumes in the shape of hyperrectangle.

The plasma processing system 400 further includes a substrate support 440 disposed in the processing volume 441. The substrate support 440 supports a substrate 401 during processing. In one embodiment, the substrate support 440 is an electrostatic chuck. A bias power 420 and a matching network 421 may be connected to the substrate support 440. The bias power 420 provides bias potential to a plasma generated in the processing volume 441.

In the embodiment shown, the substrate support 440 is surrounded by a ring-shaped cathode liner 456. A plasma containment screen or baffle 452 covers the top of the cathode liner 456 and covers a peripheral portion of the substrate support 440. The baffle 452 and cathode liner 456 may have an aluminum coating and an anodized coating as described above to improve their service life. The substrate support 440 may contain materials that are incompatible or vulnerable to a corrosive plasma processing environment, and the cathode liner 456 and the baffle 452 isolate substrate support 440 from the plasma and contain the plasma within the processing volume 441, respectively. In one embodiment, the cathode liner 456 and baffles 452 may include a high purity aluminum coating covered by a hard anodization layer that is resistive to the plasma contained within the processing volume 441.

A plasma screen 450 is disposed on top of the substrate support 440 to control the spatial distribution of charged and neutral species of the plasma across the surface of the substrate 401. In one embodiment, the plasma screen 450 includes a substantially flat member electrically isolated from the chamber walls and comprises a plurality of apertures that vertically extend through the flat member. In one embodiment, the plasma screen 450 is the plasma screen 300 as described above in relation to FIGS. 3 and 3A. The plasma screen 450 may include a high purity aluminum coating and a hard anodized coating as described above which resists the process environment within the processing volume 441.

In one embodiment, the lid 443 has an opening 444 to allow entrance of one or more processing gases. In one embodiment, the opening 444 may be disposed near a center axial of the plasma processing system 400 and correspond to the center of the substrate 401 being processed.

In one embodiment, the plasma processing system 400 includes a chamber extension 451 disposed over the lid 443 covering the opening 444. In one embodiment, the chamber extension 451 is disposed inside a coil antenna of the antenna assembly 470. The chamber extension 451 defines an extension volume 442 in fluid communication with the processing volume 441 via the opening 444.

In one embodiment, the plasma processing system 400 includes a baffle nozzle assembly 455 disposed through the opening 444 in the processing volume 441 and the extension volume 442. The baffle nozzle assembly 455 directs one or more processing gases into the processing volume 441 through the extension volume 442. In one embodiment, the baffle nozzle assembly 455 has a by-pass path allowing a processing gas to enter the processing volume 441 without going through the extension volume 442. The baffle nozzle assembly 455 may be fabricated from aluminum using the method 200 described above.

Because the extension volume 442 is within the inner antenna volume 474, processing gas in the extension volume 442 is exposed to the magnetic field of the inner coil antenna 472 prior to entering the processing volume 441. The usage of the extension volume 42 increases the plasma intensity within the processing volume 441 without increase power applied to the inner coil antenna 472 or the outer coil antenna 471.

The plasma processing system 400 includes a pump 430, and a throttle valve 435 to provide vacuum and exhaust the processing volume 441. The throttle valve 435 may include a gate valve spool 454. The gate valve spool 454 may be fabricated from aluminum using the method 200 described above. The plasma processing system 400 may further include a chiller 445 to control the temperature of the plasma processing system 400. The throttle valve 435 may be disposed between the pump 430 and the chamber body 425 and may be operable to control pressure within the chamber body 425.

The plasma processing system 400 also includes a gas delivery system 402 to provide one or more processing gases to the processing volume 441. In one embodiment, the gas delivery system 402 is located in a housing 405 disposed directly adjacent, such as under, the chamber body 425. The gas delivery system 402 selectively couples one or more gas sources located in one or more gas panels 404 to the baffle nozzle assembly 455 to provide process gases to the chamber body 425. In one embodiment, the gas delivery system 402 is connected to the baffle nozzle assembly 455 to provide gases to the processing volume 441. In one embodiment, the housing 405 is located in close proximity to the chamber body 425 to reduce gas transition time when changing gases, minimize gas usage, and minimize gas waste.

The plasma processing system 400 may further include a lift 427 for raising and lowering the substrate support 440 that supports the substrate 401 in the chamber body 425.

The chamber body 425 is protected by a lower liner 422 and an upper liner 423 which may be aluminum and fabricated using the method 200 describe above.

The gas delivery system 402 may be used to supply at least two different gas mixtures to the chamber body 425 at an instantaneous rate as further described below. In an optional embodiment, the plasma processing system 400 may include a spectral monitor operable to measure the depth of an etched trench and a deposited film thickness as the trench is being formed in the chamber body 425, with the ability to use other spectral features to determine the state of the reactor. The plasma processing system 400 may accommodate a variety of substrate sizes, for example a substrate diameter of up to about 300 mm.

Various chamber components in the processing system 400 described above may be fabricated using the aluminum coating and hard anodization described above. These chamber components are frequently exposed to the plasma processing environment. For example, aluminum and anodized coatings may be applied to the chamber body 425, the chamber body upper liner 423, the chamber body lower liner 422, a chamber body plasma door 424, a cathode liner 456, a chamber lid gas ring, a throttling gate valve spool 454, a plasma screen 450, the baffle nozzle assembly 455, baffles 452, and a pedestal or substrate support 440.

With the example and explanations above, the features and spirits of the embodiments of the disclosure are described. Those skilled in the art will readily observe that numerous modifications and alterations of the device may be made while retaining the teaching of the disclosure. Accordingly, the above disclosure should be construed as limited only by the metes and bounds of the appended claims.

What is claimed is:

1. A chamber component, for use in a plasma processing apparatus, comprising:
an aluminum body having a polished aluminum coating disposed on an outer surface of the body and a hard anodized coating disposed on the aluminum coating, wherein the polished aluminum coating is polished to a finish of 8 Ra or smoother.

2. The chamber component of claim 1, wherein the polished aluminum coating is non-mechanically polished.

3. The chamber component of claim 1, wherein the polished aluminum coating comprises a layer of high purity aluminum.

4. The chamber component of claim 1, wherein the polished aluminum coating is disposed on the outer surface of the aluminum body using at least one of electrodepositing or ion vapor deposition (IVD).

5. The chamber component of claim 1, wherein the hard anodized coating further is mechanically cleaned with a non-depositing material such as Scotch Brite.

6. An apparatus for use in a plasma processing chamber having a substrate pedestal adapted to support a substrate, comprising:
a plate having a plurality of apertures formed therethrough and configured to control the spatial distribution of charged and neutral species of the plasma, the plate having a polished layer of aluminum disposed on an outer surface of the plate and a hard anodized coating disposed on the aluminum layer, wherein the layer of aluminum is polished to a finish of 8 Ra or smoother.

7. The apparatus of claim 6, further comprising:
a plurality of support legs supporting the plate above the pedestal.

8. The apparatus of claim 6, wherein the polished layer of aluminum is non-mechanically polished.

9. The apparatus of claim 6, wherein the polished layer of aluminum comprises a layer of high purity aluminum.

10. The apparatus of claim 6, wherein the polished layer of aluminum is disposed on the outer surface of the aluminum body using at least one of electrodepositing or ion vapor deposition (IVD).

11. The apparatus of claim 6, wherein the hard anodized coating further is mechanically cleaned with a non-depositing material such as Scotch Brite.

12. A method for fabricating a chamber component for use in a plasma processing environment, comprising:
forming a body of the chamber component from aluminum;
polishing the surface of body;
depositing a layer of aluminum on the body;
polishing the surface of the aluminum layer; and
hard anodizing the aluminum layer.

13. The method of claim 12, wherein polishing the surface of the aluminum layer comprises polishing the surface of the aluminum layer to a finish of 8 Ra or smoother.

14. The method of claim 12, wherein polishing the surface of the aluminum layer comprises non-mechanically polishing the surface of the aluminum layer.

15. The method of claim 12, wherein depositing the layer of aluminum comprises depositing a layer of high purity aluminum on the surface of the body.

16. The method of claim 15, wherein depositing the layer of aluminum comprises depositing the layer of aluminum using at least one of electrodepositing or ion vapor deposition (IVD).

17. The method of claim 12, further comprising: mechanically cleaned with a non-depositing material such as Scotch Brite cleaning the hard anodized layer.
